(19) United States
(12) Patent Application Publication
(10) Pub. No.: US 2020/0324849 A1
(43) Pub. Date: Oct. 15, 2020

(54) SUSPENSION ASSEMBLY

(71) Applicant: HAYES BICYCLE GROUP INC., Mequon, WI (US)

(72) Inventor: Nicholas W. PYE, Carrboro, NC (US)

(73) Assignee: HAYES BICYCLE GROUP INC, Mequon, WI (US)

(21) Appl. No.: 16/843,896

(22) Filed: Apr. 9, 2020

Related U.S. Application Data
(60) Provisional application No. 62/832,241, filed on Apr. 10, 2019.

(51) Int. Cl. B62K 25/08

(52) U.S. Cl. CPC B62K 25/08; B62K 2025/048

(57) ABSTRACT

A suspension assembly for a bicycle is disclosed. The suspension assembly may be configured to use a volume of fluid in a fluid circuit for damping may comprise a volume compensator such as a bladder configured to provide an expandable volume to contain fluid in the fluid circuit and a relief valve configured to open to facilitate the flow of fluid through the relief valve rather than entering the volume compensator. The relief valve may be configured to open at a threshold setting. The volume compensator may comprise an expandable bladder. The threshold setting of the relief valve may be selected to prevent failure of the expandable bladder. The volume compensator and the valve may be contained in the fork assembly. The valve may be configured to open to facilitate the flow of fluid through the valve rather than expanding the volume compensator.

### CROSS-REFERENCE TO RELATED APPLICATION(S)

The present invention claims priority to and incorporates by reference in entirety the following U.S. patent application(s): (a) U.S. Provisional Patent Application No. 62/832,241 titled “SUSPENSION ASSEMBLY,” filed Apr. 10, 2019.

### FIELD

The present invention relates to a suspension assembly for a bicycle.

### BACKGROUND

It is known to provide a suspension assembly for a bicycle providing a damping system comprising a volume compensator such as an expandable bladder for fluid in the fluid circuit of the damping system. It is also known that the volume of fluid in the fluid circuit of the damping system may increase due to leaks from oil such as semi-bath oil. Increase in the volume of the fluid in the fluid circuit of the damping system may cause a failure/rupture of the volume compensator/bladder.

It would be advantageous to provide an improved suspension assembly configured to provide one or more advantageous features. It would be advantageous to provide a suspension assembly configured to provide a relief valve so that in the event that the volume of fluid in the fluid circuit of the damping system increases the relief valve will open to prevent damage such as failure/rupture of the volume compensator/bladder.

### SUMMARY

The present invention relates to a suspension assembly configured to use a volume of fluid in a fluid circuit for damping comprising a volume compensator configured to provide an expandable volume to contain fluid in the fluid circuit and a valve configured to open to facilitate the flow of fluid through the valve to limit expansion of the volume of the volume compensator. The valve may comprise a relief valve; the valve may be configured to open at a threshold setting. The volume compensator may comprise a bladder. The valve may comprise a flow control element. The valve may be installed in an end cap. The valve may be installed adjacent the volume compensator. The valve may comprise a spring; and the threshold setting may be determined by the spring. The threshold setting may be selected based on a capacity of the volume compensator. The volume compensator may comprise a bladder comprising an expandable volume. The threshold setting may be intended to prevent the volume of fluid flowing into the bladder from exceeding the expandable volume of the bladder to prevent rupture of the bladder. The fluid circuit may be configured so that the volume of fluid in the fluid circuit may comprise hydraulic fluid for damping; the volume of fluid in the fluid circuit may comprise a first hydraulic fluid and a second hydraulic fluid; the second hydraulic fluid may comprise oil; the oil may comprise oil that has leaked into the fluid circuit during operation; the volume of fluid in the fluid circuit may comprise hydraulic fluid and oil; the oil may comprise semi-bath oil that has leaked into the fluid circuit through a seal during damping. The fluid circuit may comprise a first chamber and a second chamber; the fluid circuit may be configured so that fluid flows from the first chamber into the second chamber and into the volume compensator during damping. The fluid circuit may be configured so that fluid flows from the first chamber into the second chamber and into the volume compensator and through the valve into a third chamber during damping. The volume compensator may comprise a bladder.

The present invention relates to a suspension assembly configured to use a volume of fluid in a fluid circuit for damping comprising a volume compensator configured to provide an expandable volume to contain fluid in the fluid circuit and a valve configured to open to facilitate the flow of fluid through the valve to limit expansion of the volume of the volume compensator; the valve may be configured to open at a threshold setting. The valve may comprise a relief valve. The volume compensator may comprise an expandable bladder; the threshold setting of the relief valve may be selected to prevent failure of the expandable bladder.

The present invention relates to a suspension assembly configured to use a volume of fluid in a fluid circuit for damping comprising a fork assembly and a volume compensator configured to provide an expandable volume to contain fluid in the fluid circuit and a valve configured to open to facilitate the flow of fluid through the valve to limit expansion of the volume of the volume compensator. The volume compensator and the valve may be contained in the fork assembly. The fluid circuit may comprise a first chamber and a second chamber; the fluid circuit may be configured so that fluid flows from the first chamber into the second chamber and into the volume compensator during damping; the fluid circuit may be configured so that fluid flows from the first chamber into the second chamber and into the volume compensator and through the valve into a third chamber during damping. The volume compensator may comprise an expandable bladder; a threshold setting of the valve may be selected to prevent failure of the expandable bladder.

The present invention relates to a suspension assembly configured to use a volume of fluid in a fluid circuit for damping comprising a volume compensator configured to provide an expandable volume to contain fluid in the fluid circuit with an improvement comprising a valve configured to open to facilitate the flow of fluid through the valve rather than entering the volume compensator. The valve may comprise a relief valve. The volume compensator may comprise a bladder. The valve may be configured to open at a threshold setting. The valve may comprise a spring. The valve may be configured to open at a threshold setting determined by the spring. The valve may comprise a valve element. The valve may comprise a flow control element. The valve may be installed in an end cap. The valve may be installed adjacent the volume compensator. The valve may comprise a spring; and the threshold setting may be determined by the spring. The valve may be configured to open at a threshold setting; and the threshold setting may be selected based on a capacity of the volume compensator. The volume compensator may comprise a bladder comprising an expandable volume. The threshold setting may be intended to prevent the volume of fluid flowing into the bladder from exceeding the expandable volume of the bladder. The threshold setting may be selected to prevent failure of the bladder. The threshold setting may be intended to prevent the volume of fluid flowing into the bladder from exceeding the expandable volume of the bladder to prevent rupture of the bladder. The fluid circuit may be configured so that the volume of fluid in the fluid circuit may comprise hydraulic fluid for damping. The volume of fluid in the fluid circuit may comprise a first hydraulic fluid and a second hydraulic fluid. The second hydraulic fluid may comprise oil. The oil may comprise oil that has leaked into the fluid circuit during operation. The volume of fluid in the fluid circuit may comprise hydraulic fluid and oil. The oil may comprise semi-bath oil that has leaked into the fluid circuit through a seal during damping. The fluid circuit may comprise a first chamber and a second chamber. The fluid circuit may be configured so that fluid flows from the first chamber into the second chamber during damping. The fluid circuit may be configured so that fluid flows from the first chamber into the second chamber and into the volume compensator during damping. The fluid circuit may be configured so that fluid flows from the first chamber into the second chamber and into the volume compensator and through the valve during damping. The fluid circuit may be configured so that fluid flows through the valve into a third chamber. The volume compensator may comprise a bladder. The volume compensator may comprise an elastomeric bladder. The volume compensator and the valve may be contained in the fork assembly. The valve may be configured to open to facilitate the flow of fluid through the valve rather than expanding the volume compensator.

The present invention relates to a suspension assembly configured to use a volume of fluid in a fluid circuit for damping comprising a volume compensator configured to provide an expandable volume to contain fluid in the fluid circuit and a valve configured to open to facilitate the flow of fluid through the valve rather than entering the volume compensator; the valve may be configured to open at a threshold setting. The valve may comprise a relief valve. The volume compensator may comprise an expandable bladder. The threshold setting of the relief valve may be selected to prevent failure of the expandable bladder.

### FIGURES

FIG. 1 is schematic perspective view of a bicycle according to an exemplary embodiment.

FIGS. 2 and 3 are schematic side elevation views of a suspension assembly according to an exemplary embodiment.

FIGS. 4 and 5 are schematic side elevation cross-section views of a suspension assembly for a bicycle according to an exemplary embodiment.

FIG. 6 is a schematic exploded perspective view of a suspension assembly for a bicycle according to an exemplary embodiment.

FIGS. 7A and 7B are schematic side elevation cross-section views of operation of a suspension assembly for a bicycle according to an exemplary embodiment.

FIGS. 8A through 8C are schematic side elevation cross-section views of operation of a suspension assembly for a bicycle according to an exemplary embodiment.

FIGS. 9A and 9B are schematic side elevation cross-section views of operation of a suspension assembly for a bicycle according to an exemplary embodiment.

FIG. 10 is a schematic diagram of operation/failure of a volume compensator of a suspension assembly according to an exemplary embodiment.

FIGS. 11A and 11B are schematic side elevation cross-section views of a flow control element of a suspension assembly for a bicycle according to an exemplary embodiment.

FIG. 12 is a schematic flow circuit diagram of a suspension assembly for a bicycle according to an exemplary embodiment.

### DESCRIPTION

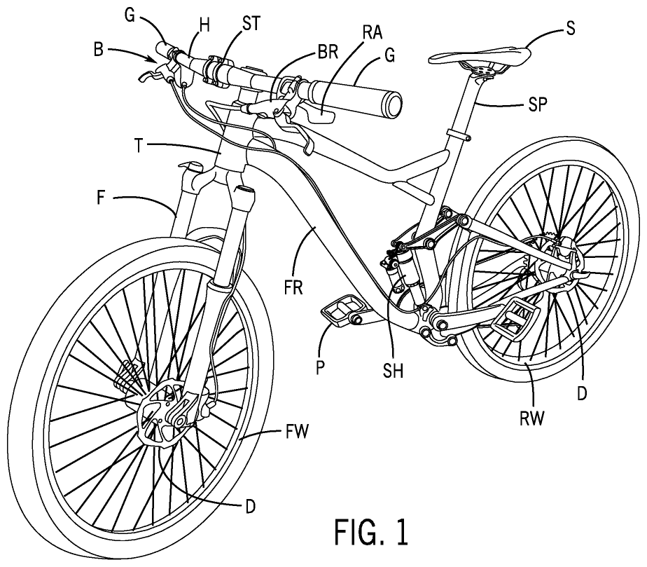

Referring to FIG. 1, a bicycle B (such as a mountain bike) is shown schematically according to an exemplary embodiment providing an arrangement of parts/components including a frame FR with a steering tube T and a seat post SP (with seat S) and a set of wheels comprising front wheel FW with a front fork assembly F and rear wheel RW coupled to the frame FR and through a rear shock absorber SH (of a suspension system) and a set of pedals P; the bicycle provides handlebar H (coupled to front wheel FW through stem ST and front fork assembly F and through steering tube T) with a grip G and controls for a brake system BR coupled to a brake disc D (e.g. rotor at/on each of front wheel FW and rear wheel RW) and a remote actuator RA.

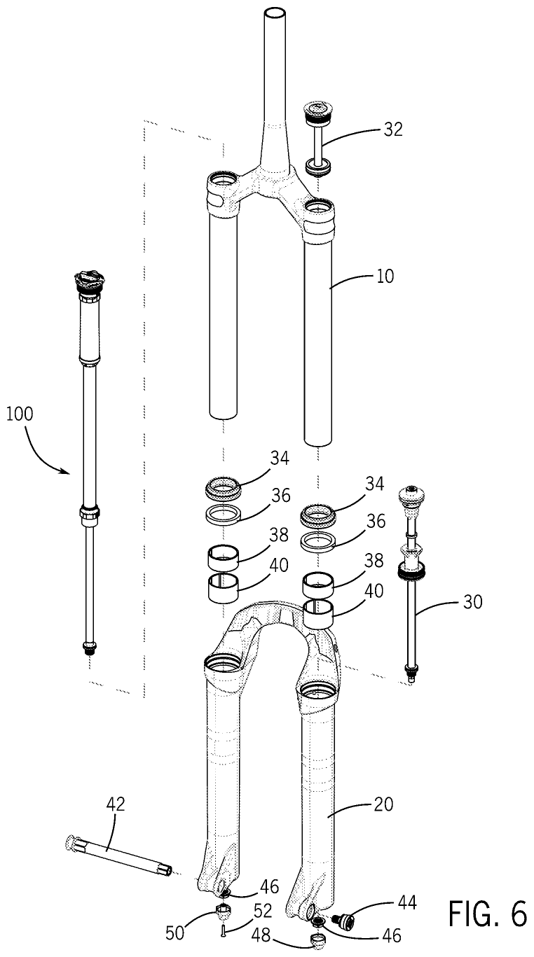

Referring to FIGS. 1, 2, 3, 4, 5 and 6, a suspension system shown as suspension/fork assembly F (e.g. for the front fork of a bicycle) configured to provide suspension damping is shown schematically according to an exemplary embodiment.

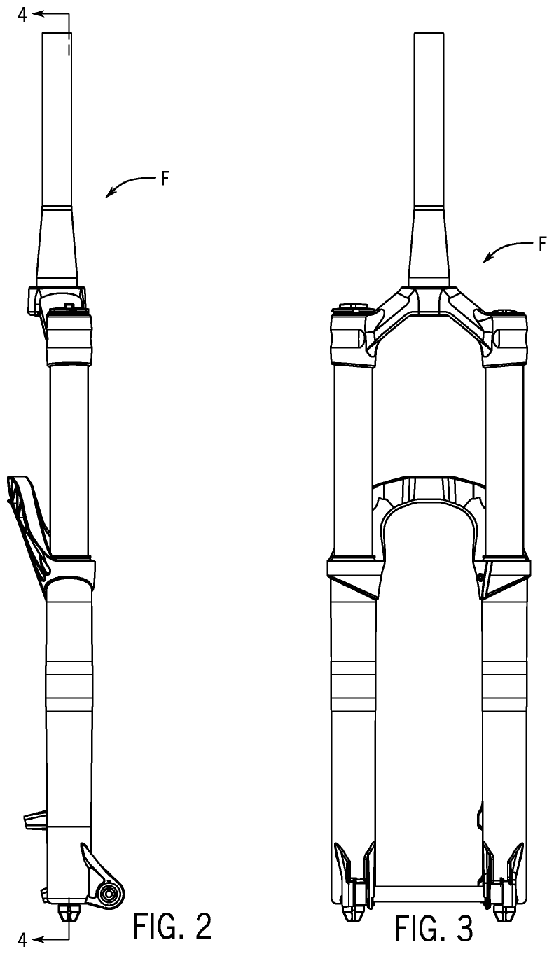

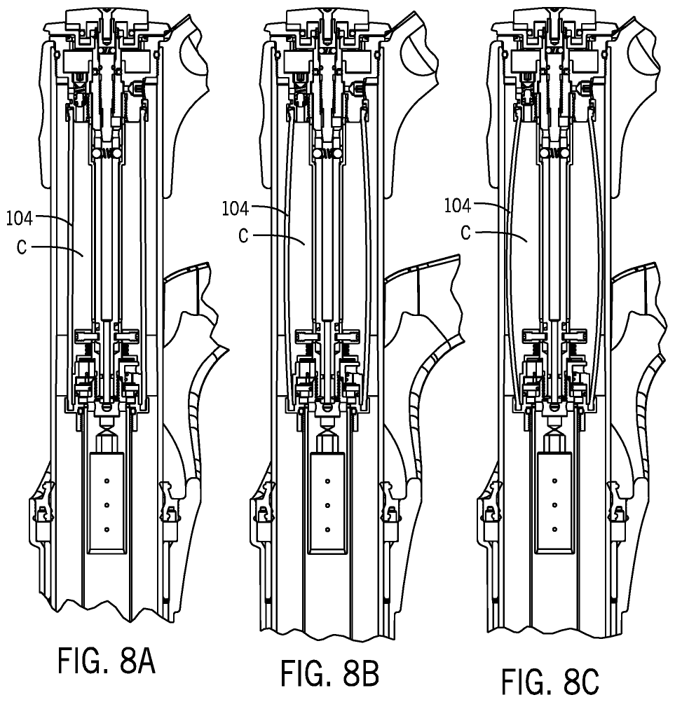

As shown schematically in FIGS. 2, 3, 4, 5 and 6, the suspension system comprises an upper fork assembly 10 providing a set of inner tubes and a lower fork assembly 20 providing a set of outer tubes (configured for installation/insertion of the inner tubes for assembly); a piston/damper assembly 100 comprising a stem and a set of seals is installed/secured in the base of the lower fork assembly and attached/secured by a top cap 110 in the corresponding tube of the upper fork assembly. See also FIGS. 8A-8C, 9A-9B and 11A-11B.

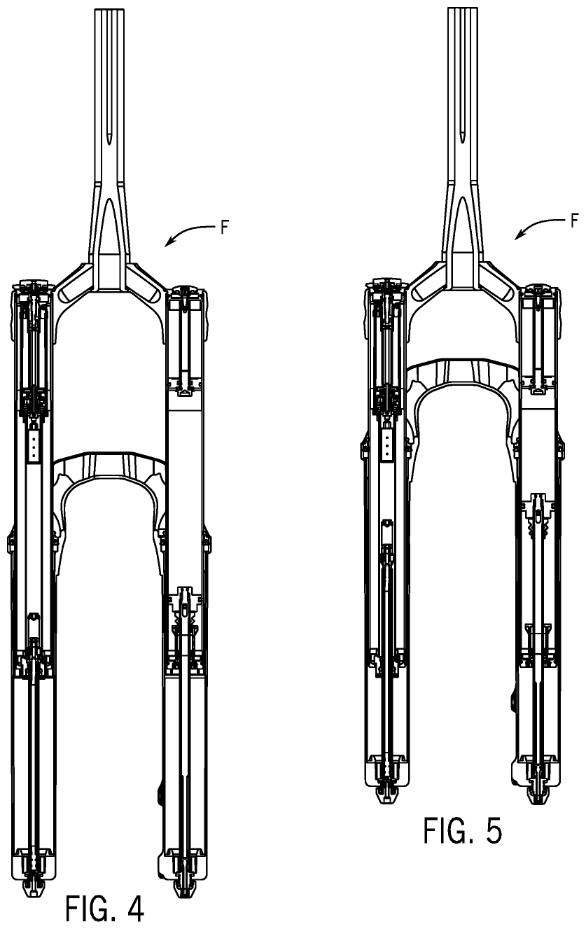

As indicated schematically in FIGS. 4-5 and 7A-7B, the suspension system for the front fork of the bicycle is configured to facilitate flow of hydraulic/suspension fluid (e.g. a contained volume of fluid) to provide suspension damping as the front wheel of the bicycle encounters irregularities (e.g. bumps, obstacles. holes, etc.). See also FIGS. 8A-8C and 9A-9B and 12. In operation when the suspension system is use (e.g. to provide suspension damping in response to an input such as from an irregularity encountered by the front wheel) the fork assembly F will be compressed/shortened; after the input, the fork assembly F will return to a default/extended condition (e.g. ready to encounter input to provide suspension damping at the front wheel). See FIGS. 4 and 5.

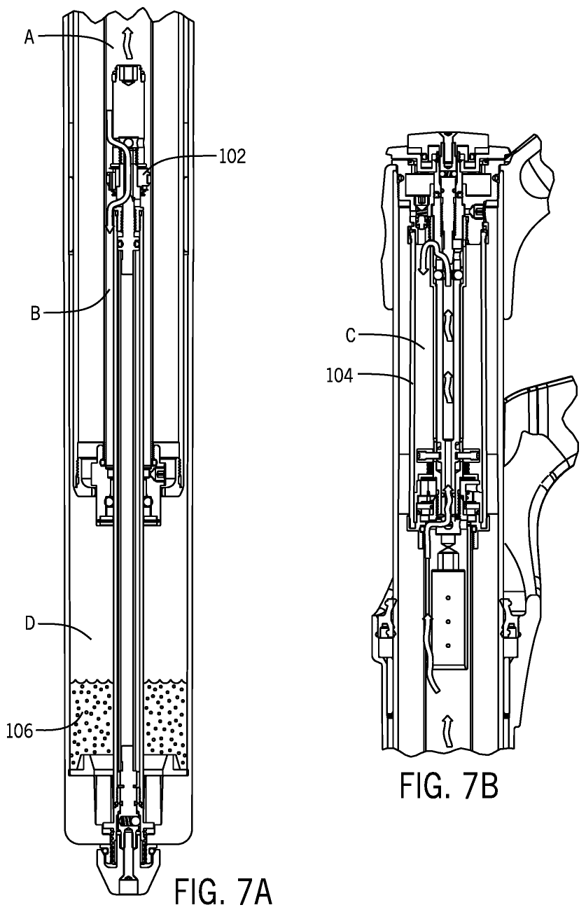

As shown schematically in FIGS. 7A-7B, the suspension system comprises a suspension tube/tube assembly configured to provide a chamber D (e.g. fourth chamber) in lower fork assembly 20 with chambers A and B (e.g. first chamber and second chamber) in an upper fork assembly 10 and a volume compensator shown as bladder arrangement 104 to contain the fluid in a chamber shown as chamber C (e.g. third chamber); the bladder 104 is configured to provide an expandable volume for chamber C to contain the fluid in operation. The suspension system also contains a volume of air (e.g. within the lower fork assembly and upper fork assembly) separated from the fluid; the bladder 104 is configured to expand into the upper fork assembly (e.g. into the volume of an air space in the upper fork assembly) without leakage/contamination of air into the contained fluid within the bladder providing suspension damping. See FIGS. 8A-8C. According to an exemplary embodiment as indicated schematically, the bladder is configured with a form/size to fit within the available space in the upper fork assembly and to contain the volume of fluid (e.g. defined fluid volume for the damping circuit) that will flow from the first chamber during compression of the suspension system.

As shown schematically in FIG. 7A, the suspension system also contains a volume of oil 106 (e.g. semi-bath oil for lubrication/coating of surfaces) provided at the base of the lower fork assembly. See also FIGS. 4-5.

When the suspension system is in a default state (e.g. not in use or not providing suspension damping) the volume of hydraulic fluid will be contained in the suspension assembly (e.g. main chamber D); the lower fork assembly and upper fork assembly of the suspension assembly is in a default/extended condition.

In operation when the suspension system is use (e.g. to provide suspension damping in response to an input such as from an irregularity encountered by the front wheel) the fork assembly will be compressed/shortened with lower fork assembly entering the upper fork assembly and fluid previously contained in the first chamber A of the upper fork assembly will flow into the second chamber B of the upper fork assembly (through a flow control element/valve arrangement shown schematically) and into the third chamber C provided by bladder 104 (through a flow control element/valve arrangement shown schematically) and the bladder 104 will expand (e.g. into the air volume) to accommodate the fluid. See FIGS. 5, 7A-7B and 8A-8C. After the input, the fork assembly will return to the default/extended condition (e.g. ready to encounter input to provide suspension damping at the front wheel) with flow of fluid returning from the third chamber C provided by the bladder 104 to the first chamber A and from the second chamber B to the first chamber A. See FIGS. 4 and 7A.

In operation of the suspension system over time, a certain portion of the oil provided for coating/lubrication may leak into the fluid provided for suspension damping (e.g. leakage, injection, etc. through a seal); as a result the total contained volume of fluid (e.g. fluid and oil) may enlarge beyond the volume of fluid that can be contained within expandable bladder at full expansion; it is possible that the bladder may fail/rupture if the total volume of fluid in the damping circuit exceeds a defined threshold (e.g. in excess of design/maximum fluid volume capacity for the damping circuit). See FIGS. 7A, 8C and 10.

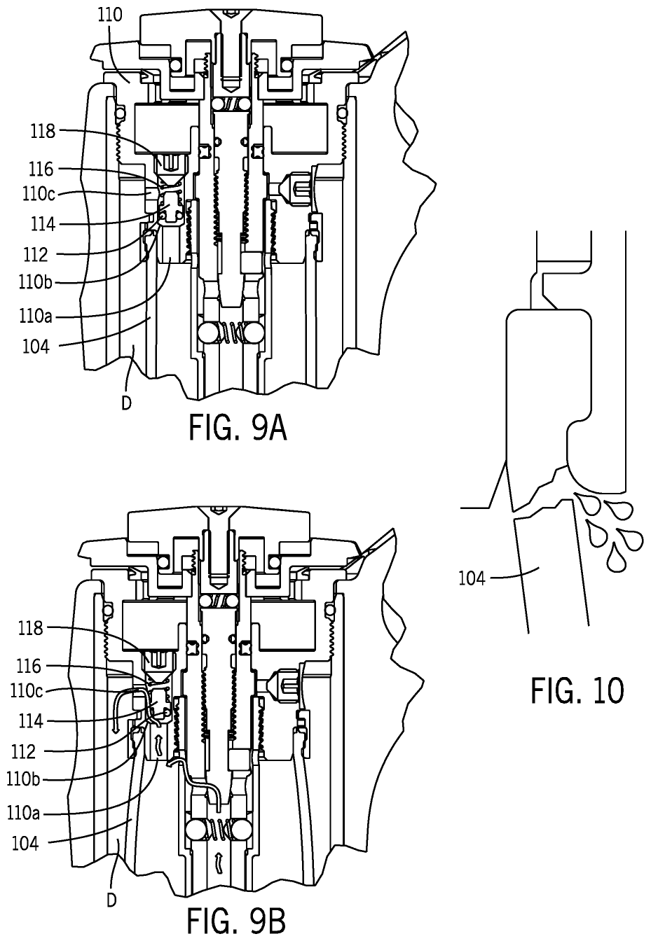

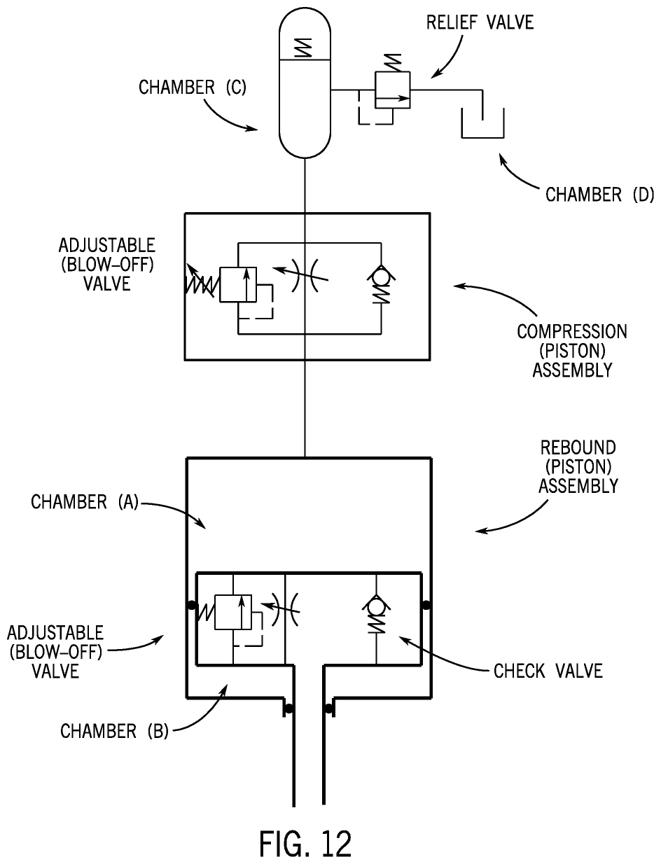

As indicated schematically in FIGS. 9A-9B, 11A-11B and 12, the suspension system may be provided with a relief valve system in parallel to the bladder arrangement 104; the relief valve system comprises a flow control/relief valve arrangement configured to open to allow flow of fluid from the first chamber A of the fork assembly into the air space in the upper fork assembly and into the fourth chamber D of the lower fork assembly to prevent failure/rupture of the bladder 104 in the event that the volume of fluid (e.g. fluid and oil) exceeds a threshold value (e.g. volume large than the total design capacity of the bladder and chambers). See also FIGS. 8A-8C and 12.

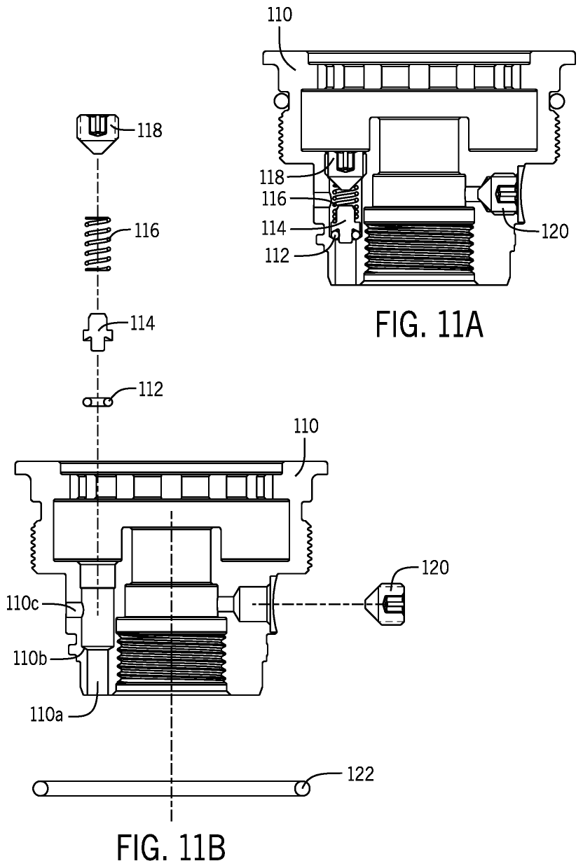

As shown schematically according to an exemplary embodiment in FIG. 8A-8C, the bladder 104 is secured between the compression piston assembly and the top cap 110 for the fork assembly F; the relief valve system for the bladder arrangement is provided at the top cap 110 (and comprises a bleed screw 120 and seals 112 and 122). See also FIGS. 9A-9B and 11A-11B.

As shown schematically in FIGS. 9A-9B and 11A-11B, the relief valve system RS comprises a flow control/valve arrangement comprising a poppet/valve 114 and a spring 116 secured by a fitting shown as set screw 118; the valve/spring arrangement is configured to remain closed in standard operation (e.g. with the valve retained closed in a seat by the spring providing a force on the valve/poppet) (see FIG. 9A) and to open under pressure (e.g. with the valve opening by separation from the seat under fluid pressure sufficient to overcome the force of the spring) to allow flow when the volume of fluid in the damping circuit for the suspension system exceeds the defined volume of fluid for the suspension system (see FIG. 9B). See also FIG. 12.

### Exemplary Embodiments

According to an exemplary embodiment shown schematically, a suspension assembly configured to use a volume of fluid in a fluid circuit for damping comprising a volume compensator (shown as an elastomeric bladder) configured to provide an expandable volume to contain fluid in the fluid circuit with an improvement may a valve configured to open to facilitate the flow of fluid through the valve rather than entering the volume compensator (e.g. bladder). See e.g. FIGS. 8A-8C and 9A-9B.

The valve may comprise a relief valve. See e.g. FIGS. 9A-9B and 11A-11B. The volume compensator may comprise a bladder. See e.g. FIGS. 8A-8C. The valve may be configured to open at a threshold setting. The valve may comprise a spring. See e.g. FIGS. 9A-9B and 11A-11B. The valve may be configured to open at a threshold setting determined by the spring; the valve may comprise a flow control element such as a valve element/poppet. See e.g. FIGS. 9A-9B and 11A-11B. The valve may be installed in an end cap. See e.g. FIGS. 9A-9B. The valve may be installed adjacent the volume compensator. See e.g. FIGS. 8C and 9B. The valve may comprise a spring; and the threshold setting may be determined by the spring; the valve may be configured to open at a threshold setting; and the threshold setting may be selected based on a capacity of the volume compensator.

The volume compensator may comprise a bladder comprising an expandable volume. See e.g. FIGS. 8A-8C. The threshold setting may be intended to prevent the volume of fluid flowing into the bladder from exceeding the expandable volume of the bladder. The threshold setting may be selected to prevent failure of the bladder. Compare FIGS. 9B and 10. The threshold setting may be intended to prevent the volume of fluid flowing into the bladder from exceeding the expandable volume of the bladder to prevent rupture of the bladder.

The fluid circuit may be configured so that the volume of fluid in the fluid circuit may comprise hydraulic fluid for damping. The volume of fluid in the fluid circuit may comprise a first hydraulic fluid and a second hydraulic fluid. The second hydraulic fluid may comprise oil. The oil may comprise oil that has leaked into the fluid circuit during operation. The volume of fluid in the fluid circuit may comprise hydraulic fluid and oil. The oil may comprise semi-bath oil that has leaked into the fluid circuit through a seal during damping. See e.g. FIG. 7A-7B and 9B. See also FIG. 10.

The fluid circuit may comprise a first chamber and a second chamber. See e.g. FIGS. 7A-7B. The fluid circuit may be configured so that fluid flows from the first chamber into the second chamber during damping. See e.g. FIGS. 7A-7B. The fluid circuit may be configured so that fluid flows from the first chamber into the second chamber and into the third chamber provided by the volume compensator/bladder during damping. See e.g. FIGS. 8A-8B. The fluid circuit may be configured so that fluid flows from the first chamber into the second chamber and into the volume compensator/bladder and through the valve (e.g. relief valve) during damping. See e.g. FIGS. 9A-9B. The fluid circuit may be configured so that fluid flows through the valve into a fourth chamber (to semi-bath fluid). See e.g. FIGS. 8C and 9B.

The volume compensator may comprise a bladder such as an elastomeric bladder. See e.g. FIGS. 8A-8C. The volume compensator and the valve may be contained in the fork assembly. See e.g. FIGS. 2, 3, 4, 5, 8A-8C, and 9A-9B. The valve may be configured to open to facilitate the flow of fluid through the valve rather than expanding the volume compensator. See e.g. FIGS. 9B and 11A.

According to an exemplary embodiment shown schematically, a suspension assembly configured to use a volume of fluid in a fluid circuit for damping may comprise a volume compensator such as a bladder configured to provide an expandable volume to contain fluid in the fluid circuit and a valve configured to open to facilitate the flow of fluid through the valve rather than entering the volume compensator; the valve may be configured to open at a threshold setting. See e.g. FIGS. 7A-7B, 8A-8C and 9A-9B. The valve may comprise a relief valve. See e.g. FIGS. 9A-9B and 11A-11B. The volume compensator may comprise an expandable bladder. See e.g. FIGS. 8A-8C and 9B. The threshold setting of the relief valve may be selected to prevent failure of the expandable bladder. Compare FIGS. 9B and 10.

TABLE A
REFERENCE SYMBOL LIST

| REFERENCE | ELEMENT, PART, COMPONENT |
|---|---|
| SYMBOL | OR ASSEMBLY |
| B | BICYCLE |
| FR | FRAME |
| FW | FRONT WHEEL |
| RW | REAR WHEEL |
| SP | SEAT POST |
| S | SEAT |
| T | STEERING TUBE |
| ST | STEM |
| H | HANDLEBAR |
| G | GRIP (HANDLEBAR) |
| F | FRONT FORK ASSEMBLY |
| SH | REAR SHOCK ABSORBER FOR SUSPENSION |
| | SYSTEM |
| BR | BRAKE SYSTEM |
| D | DISC/ROTOR (BRAKE) |
| P | PEDAL |
| RA | REMOTE ACTUATOR |
| F | FORK ASSEMBLY |

TABLE B
REFERENCE SYMBOL LIST

| REFERENCE | ELEMENT, PART, COMPONENT |
|---|---|
| SYMBOL | OR ASSEMBLY |
| F | FORK ASSEMBLY |
| 10 | UPPER FORK ASSEMBLY |
| 20 | LOWER FORK ASSEMBLY |
| 30 | SPRING ASSEMBLY |
| 32 | VOLUME COMPENSATOR |
| 34 | SEAL |
| 36 | FOAM INSERT |
| 38 | UPPER BUSHING |
| 40 | LOWER BUSHING |
| 42 | AXLE |
| 44 | AXLE RETAINER |
| 46 | NUT |
| 48 | VALVE CAP |
| 50 | KNOB |
| 52 | SCREW |
| 100 | DAMPER ASSEMBLY |
| 102 | PISTON |
| 104 | BLADDER |
| 110 | TOP CAP |
| 110a | PASSAGE |
| 110b | SEAT |
| 110c | PASSAGE |
| 112 | SEAL |
| 114 | POPPET |
| 116 | SPRING |
| 118 | SET SCREW |
| 120 | BLEED SCREW |
| 122 | SEAL |
| A | FIRST CHAMBER |
| B | SECOND CHAMBER |
| C | THIRD CHAMBER |
| D | FOURTH CHAMBER |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A suspension assembly configured to use a volume of fluid in a fluid circuit for damping comprising:
a volume compensator configured to provide an expandable volume to contain fluid in the fluid circuit;
a valve configured to open to facilitate the flow of fluid through the valve to limit expansion of the volume of the volume compensator.

2. The suspension assembly of claim 1 wherein the valve comprises a relief valve; wherein the valve is configured to open at a threshold setting.

3. The suspension assembly of claim 1 wherein the volume compensator comprises a bladder.

4. The suspension assembly of claim 1 wherein the valve comprises a flow control element.

5. The suspension assembly of claim 1 wherein the valve is installed in an end cap.

6. The suspension assembly of claim 1 wherein the valve is installed adjacent the volume compensator.

7. The suspension assembly of claim 2 wherein the valve comprises a spring; and wherein the threshold setting is determined by the spring.

8. The suspension assembly of claim 2 wherein the threshold setting is selected based on a capacity of the volume compensator.

9. The suspension assembly of claim 2 wherein the volume compensator comprises a bladder comprising an expandable volume.

10. The suspension assembly of claim 9 wherein the threshold setting is intended to prevent the volume of fluid flowing into the bladder from exceeding the expandable volume of the bladder to prevent rupture of the bladder.

11. The suspension assembly of claim 1 wherein the fluid circuit is configured so that the volume of fluid in the fluid circuit comprises hydraulic fluid for damping; wherein the volume of fluid in the fluid circuit comprises a first hydraulic fluid and a second hydraulic fluid; wherein the second hydraulic fluid comprises oil; wherein the oil comprises oil that has leaked into the fluid circuit during operation; wherein the volume of fluid in the fluid circuit comprises hydraulic fluid and oil; wherein the oil comprises semi-bath oil that has leaked into the fluid circuit through a seal during damping.

12. The suspension assembly of claim 1 wherein the fluid circuit comprises a first chamber and a second chamber; wherein the fluid circuit is configured so that fluid flows from the first chamber into the second chamber and into the volume compensator during damping.

13. The suspension assembly of claim 12 wherein the fluid circuit is configured so that fluid flows from the first chamber into the second chamber and into the volume compensator and through the valve into a third chamber during damping.

14. The suspension assembly of claim 13 wherein the volume compensator comprises a bladder.

15. A suspension assembly configured to use a volume of fluid in a fluid circuit for damping comprising:
a volume compensator configured to provide an expandable volume to contain fluid in the fluid circuit;
a valve configured to open to facilitate the flow of fluid through the valve to limit expansion of the volume of the volume compensator;
wherein the valve is configured to open at a threshold setting.

16. The suspension assembly of claim 15 wherein the valve comprises a relief valve.

17. The suspension assembly of claim 15 wherein the volume compensator comprises an expandable bladder; wherein the threshold setting of the relief valve is selected to prevent failure of the expandable bladder.

18. A suspension assembly configured to use a volume of fluid in a fluid circuit for damping comprising:
a fork assembly;
a volume compensator configured to provide an expandable volume to contain fluid in the fluid circuit;
a valve configured to open to facilitate the flow of fluid through the valve to limit expansion of the volume of the volume compensator.
wherein the volume compensator and the valve are contained in the fork assembly.

19. The suspension assembly of claim 18 wherein the fluid circuit comprises a first chamber and a second chamber; wherein the fluid circuit is configured so that fluid flows from the first chamber into the second chamber and into the volume compensator during damping; wherein the fluid circuit is configured so that fluid flows from the first chamber into the second chamber and into the volume compensator and through the valve into a third chamber during damping.

20. The suspension assembly of claim 18 wherein the volume compensator comprises an expandable bladder; wherein a threshold setting of the valve is selected to prevent failure of the expandable bladder.
